(19) United States
(12) Patent Application Publication
(10) Pub. No.: US 2006/0244684 A1
(43) Pub. Date: Nov. 2, 2006

(54) Plasma display apparatus and driving method thereof

(75) Inventors: Byung Goo Kong, Yongin-si (KR); Jeong Pil Choi, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/411,842

(22) Filed: Apr. 27, 2006

(30) Foreign Application Priority Data
Apr. 29, 2005 (KR) 10-2005-0036036

(51) Int. Cl. G09G 3/28

(52) U.S. Cl. 345/60

(57) ABSTRACT

A plasma display apparatus which can increase driving efficiency of a plasma display panel and a driving method thereof are disclosed. The plasma display apparatus includes a plasma display panel comprising a plurality of electrodes, a driver for driving the plurality of electrodes, and a sustain pulse controller for controlling the driver and for adjusting at least one of an ER (energy recovery)-Up time period and an ER (energy recovery)-Down time period of a sustain pulse supplied to the plurality of electrodes depending on an average picture level (APL) in a sustain period.

This non-provisional application claims priority under 35 U.C. § 119(a) on Patent Application No. 10-2005-0036036 filed in Korea on Apr. 29, 2005, the entire contents of which are hereby incorporated by reference.

### BACKGROUND OF THE INVENTION

1. Field of the Invention

The present invention relates to a plasma display panel, and more particularly, to a plasma display apparatus which can increase driving efficiency of a plasma display panel and a driving method thereof.

2. Description of the Background Art

In general, in a plasma display panel, one unit cell is provided at a space between barrier ribs formed between a front panel and a rear panel. A main discharge gas such as Neon (Ne), Helium (He), or a mixture (He+Ne) of Neon and Helium and an inert gas containing a small amount of Xenon (Xe) are filled in each cell.

When discharge occurs using a high frequency voltage, the inert gas generates vacuum ultraviolet rays and phosphors provided between the barrier ribs are emitted, thereby realizing an image. The plasma display panel is considered as one of the next generation display devices due to its thin profile and light weight construction.

FIG. 1 shows a structure of a conventional plasma display panel.

As shown in FIG. 1, the plasma display panel comprises a front panel 100 and a rear panel 110 which are coupled in parallel to be opposed to each other at a given distance therebetween. A plurality of scan electrodes 102 and a plurality of sustain electrodes 103 are formed in pairs on the front panel 100 to form a plurality of sustain electrode pairs. A plurality of address electrodes 113 are formed on the rear panel 110 to intersect the plurality of sustain electrode pairs.

The front panel 100 comprises the scan electrodes 102 and the sustain electrodes 103 which generate a mutual discharge in one discharge cell and sustain light-emission of cells. The front panel 100 comprises pairs of the scan electrode 102 and the sustain electrode 103, each comprising transparent electrodes (a) made of a transparent ITO material and bus electrodes (b) made of a metal material.

The scan electrode 102 and the sustain electrode 103 are covered with at least one upper dielectric layer 104 which limits a discharge current and provides insulation between the electrode pairs. A protective layer 105 deposited with MgO is formed on an upper surface of the upper dielectric layer 104 to facilitate discharge conditions.

In the rear panel 110, a plurality of stripe-type (or well-type) barrier ribs 112 are disposed in parallel to form a plurality of discharge cells. A plurality of address electrodes 113 for generating vacuum ultraviolet rays by performing an address discharge are disposed in parallel with the barrier ribs 112.

Red (R), green (G), and blue (B) phosphors 114 which emit visible rays for displaying an image upon an address discharge are coated on an upper part of the rear panel 110. A lower dielectric layer 115 for protecting the address electrode 113 is formed between the address electrode 113 and the phosphors 114.

FIG. 2 shows a method of representing a gray level of a conventional plasma display panel.

As shown in FIG. 2, in the method of representing a gray level of a conventional plasma display panel, one frame is divided into several subfields whose the number of light-emission is different from one another. Each of the subfields comprises a reset period (RPD) for initializing all cells, an address period (APD) for selecting cells to be discharged, and a sustain period (SPD) for representing a gray level depending on the number of discharges.

For example, in case of representing an image with 256-level gray level, a frame period (16.67 ms) corresponding to 1/60 sec is divided into eight subfields (SF1 to SF8Z). Each of the eight subfields (SF1 to SF8) comprises a reset period, an address period, and a sustain period.

The duration of the reset period in a subfield is equal to the duration of the reset periods in the remaining subfields. The duration of the address period in a subfield is equal to the duration of the address periods in the remaining subfields. The voltage difference between an address electrode and a transparent electrode, which is a scan electrode, generates an address discharge for selecting the cells to be discharged.

The sustain period increases in a ratio of 2n (n=0, 1, 2, 3, 4, 5, 6, 7) in each of the subfields. As described above, since the duration of the sustain period changes in each of the subfields, gray level is represented by adjusting the sustain period of each of the subfields, i.e., the number of sustain discharges.

FIG. 3 shows driving waveforms according to a driving method of a conventional plasma display panel.

As shown in FIG. 3, the plasma display panel is driven by dividing each of subfields into a reset period, an address period, a sustain period, and an erasing period.

In the reset period, ramp-up waveforms are simultaneously applied to all scan electrodes during a setup period. A weak dark discharge is generated within the discharge cells of the entire screen by the ramp-up waveforms. By performing the set-up discharge, positive wall charges are accumulated on the address electrodes and the sustain electrodes and negative wall charges are accumulated on the scan electrodes.

In a set-down period, after a ramp-up waveform is supplied, a ramp-down waveform which falls from a positive voltage lower than a peak voltage of the ramp-up waveform to a specific voltage of a ground level voltage or less generates a weak erasing discharge within the cells. Accordingly, the weak erasing discharge sufficiently erases wall charges excessively accumulated on the scan electrode. By performing the set-down discharge, the wall charges uniformly remain within the cells to the degree that there is the generation of a stable address discharge.

In the address period, a negative scan pulse is sequentially applied to the scan electrodes and, at the same time, a positive data pulse synchronized with the scan pulse is applied to the address electrodes. While the voltage difference between the negative scan pulse and the positive data pulse is added to the wall charges produced during the reset period, the address discharge is generated within the discharge cells to which the data pulse is applied.

The wall charges necessary for a sustain discharge when applying a sustain voltage (Vs) are formed within the cells selected by performing the address discharge. A positive voltage (Vz) is supplied to the sustain electrode Z during the set-down period and the address period so that an erroneous discharge is not generated by reducing the voltage difference between the sustain electrode and the scan electrode.

In the sustain period, a sustain pulse (Sus) is alternately supplied to the scan electrode and the sustain electrode. While the wall voltage within the cells selected by performing the address discharge is added to the sustain pulse, a sustain discharge is generated between the scan electrode and the sustain electrode whenever the sustain pulse is applied.

After the sustain discharge is completed, a voltage of an erasing ramp waveform (Ramp-ers) having a small pulse width and a low voltage level is supplied to a sustain electrode to erase wall charges remaining within cells of an entire screen in an erasing period.

FIG. 4a and FIG. 4b is a diagram illustrating a sustain pulse supplied in the sustain period in driving waveforms of FIG. 3.

Referring to FIG. 4a, in a driving waveform of FIG. 3, the sustain pulse is alternately supplied to the scan electrode (Y) and the sustain electrode (Z) in a sustain period. The sustain pulse rises with a predetermined slope when a voltage rises, i.e., at ER-Up. In addition, the sustain pulse falls with a predetermined slope when a voltage falls, i.e., at ER-Down. A conventional sustain pulse rises and falls in a winding form due to a factor such as an element characteristic, etc. of a driving circuit.

Referring to FIG. 4b, the conventional sustain pulse rises and falls with a predetermined slope and has a voltage of a winding form. When the sustain pulse rises and falls with a predetermined slope, a time period thereof is determined by LC resonance by an inductance and a capacitance, and this is represented by Equation 1.
t1=2n\sqrt{LC} Equation 1

That is, when a value of at least one of the capacitance and the inductance of the panel increases, a voltage rising time period and a voltage falling time period of the sustain pulse increases.

On the other hand, in the panel, as the number of the discharge cells which are turned on increases, a capacitance value of the panel increases and as the number of the discharge cells which are turned on decreases, a capacitance value of the panel decreases. Accordingly, a voltage rising time period and a voltage falling time period of the sustain pulse supplied in a sustain period are determined depending on the number of the discharge cells which are turned on in the panel.

Since the increase in the number of the discharge cells which are turned on means the increase in a load value of the panel, a voltage rising time period and a voltage falling time period of the sustain pulse is determined depending on a load value of the panel.

FIG. 5 shows a voltage rising time period and a voltage falling time period of a sustain pulse supplied in a sustain period in a conventional driving waveform.

Referring to FIG. 5, in a conventional driving waveform, a voltage rising time period and a voltage falling time period of the sustain pulse supplied during a sustain period are determined depending on a load value of the panel. A voltage rising time period and a voltage falling time period of the sustain pulse change depending on a load value of the panel, but an ER-Up time period and an ER-Down time period, i.e., a switching time for performing ER-Up and ER-Down provided by a driving apparatus is limited. Accordingly, when a voltage of the sustain pulse rises and falls, distortion of a waveform is generated.

For example, as in FIG. 5, when approximately a half of the discharge cells of the plasma display panel is turned on, the panel is in an average load and at this time, the sustain pulse has a form of an average load shown in FIG. 5.

The average load is achieved when an ER-Up time period and an ER-Down time period provided by the driving apparatus agree with a voltage rising time period and a voltage falling time period of the sustain pulse, respectively depending on a load value. Furthermore, in the average load, because a LC resonance time period agrees with an ER-Up time period or an ER-Down time period, driving efficiency of the plasma display panel is relatively high.

When most discharge cells among the discharge cells of the plasma display panel are turned off, the panel is in a lowest load and at this time, the sustain pulse has a form of a lowest load shown in FIG. 5.

The lowest load is achieved when an ER-Up time period and an ER-Down time period provided by the driving apparatus are longer than a voltage rising time period and a voltage falling time period of the sustain pulse depending on a load value. Furthermore, in the lowest load, because the ER-Up time period or the ER-Down time period is longer than the LC resonance time period, the sustain pulse is winding. Accordingly, discharge of the plasma display panel becomes unstable and driving efficiency decreases.

Furthermore, when most discharge cells among the discharge cells of the plasma display panel are turned on, the panel is in a highest load and at this time, the sustain pulse has a form of the highest load shown in FIG. 5.

The highest load is achieved when an ER-Up time period and an ER-Down time period provided by the driving apparatus are shorter than a voltage rising time period and a voltage falling time period of the sustain pulse depending on a load value. Furthermore, in the highest load, because the ER-Up time period or the ER-Down time period is shorter than the LC resonance time period, rising of the voltage ends before the sustain pulse rises up to a highest point by LC resonance. Accordingly, in the driving apparatus, there is a problem that driving efficiency of the plasma display panel decreases due to decrease of energy recovery efficiency, etc.

### SUMMARY OF THE INVENTION

Accordingly, an object of the present invention is to solve at least the problems and disadvantages of the background art.

An object of the present invention is to provide a plasma display apparatus and driving method thereof which can improve driving efficiency of the plasma display panel by adjusting at least one of the ER-Up time period and the ER-Down time period depending on an average picture level (APL).

According to an aspect of the present invention, there is provided a plasma display apparatus comprising a plasma display panel comprising a plurality of electrodes, a driver for driving the plurality of electrodes, and a sustain pulse controller for controlling the driver and for adjusting at least one of an ER (energy recovery)-Up time period and an ER (energy recovery)-Down time period of a sustain pulse supplied to the plurality of electrodes depending on an average picture level (APL) in a sustain period.

According to another aspect of the present invention, there is provided a method of driving a plasma display apparatus comprising adjusting at least one of an ER-Up time period and an ER-Down time period of a sustain pulse supplied to a plurality of electrodes depending on an average picture level (APL) in a sustain period of plasma display panel.

According to still another aspect of the present invention, there is provided a method of driving a plasma display apparatus comprising driving a plurality of electrodes of a plasma display panel in a reset period and an address period, and adjusting at least one of an ER-Up time period and an ER-Down time period of a sustain pulse supplied to the plurality of electrodes depending on the number of sustain pulses in a sustain period.

According to further aspect of the present invention, there is provided a plasma display apparatus comprising a plasma display panel comprising a plurality of electrodes, a driver for driving the plurality of electrodes, and a sustain pulse controller for controlling the driver, for adjusting at least one of an ER-Up time period and an ER-Down time period of a sustain pulse supplied to the plurality of electrodes depending on an average picture level (APL) in a sustain period, and for setting the ER-Up time period to be shorter than the ER-Down time period.

### BRIEF DESCRIPTION OF THE DRAWINGS

The invention will be described in detail with reference to the following drawings in which like numerals refer to like elements.

FIG. 1 is a view illustrating a structure of a conventional plasma display panel;

FIG. 2 is a diagram illustrating a method of representing a gray level of the conventional plasma display panel;

FIG. 3 is a diagram illustrating driving waveforms according to a driving method of the conventional plasma display panel;

FIG. 4a and FIG. 4b is a diagram illustrating a sustain pulse supplied in a sustain period in driving waveforms of FIG. 3;

FIG. 5 is a diagram illustrating a voltage rising time period and a voltage falling time period of a sustain pulse supplied in a sustain period in a conventional driving waveform;

FIG. 6 is a diagram illustrating a structure of a plasma display apparatus according to an embodiment of the present invention;

FIG. 7 is a diagram illustrating an average picture level (APL);

FIG. 8 is a diagram illustrating an embodiment of a driving method of a plasma display apparatus of the present invention;

FIG. 9 is a diagram illustrating a form of a LC resonance of a sustain pulse according to an average picture level in a driving waveform of FIG. 8;

FIG. 10a and FIG. 10b is a diagram illustrating a method of adjusting only one of an ER-Up time period and an ER-Down time period depending on an average picture level in a driving waveform of the present invention; and

FIG. 11 is a diagram illustrating a method of uniformly maintaining a length of the duration of a sustain voltage of a sustain pulse while adjusting an ER-Up time period and an ER-Down time period depending on an average picture level in a driving waveform of the present invention.

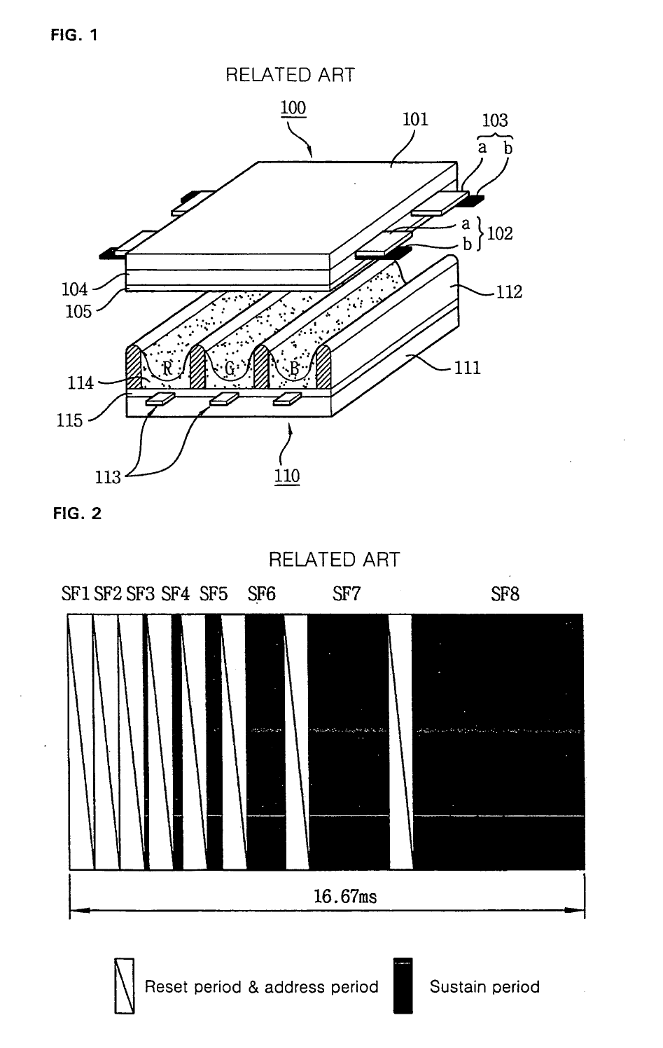

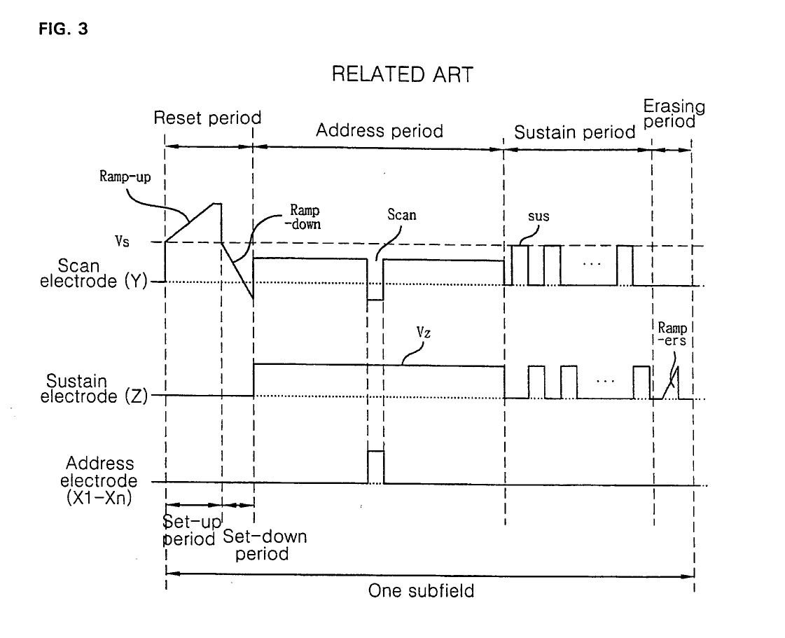

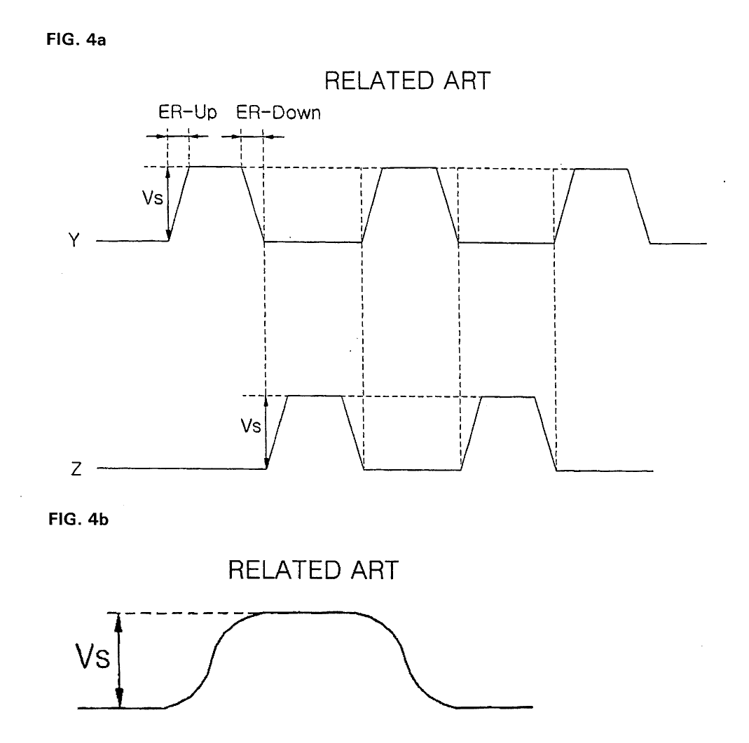

### DETAILED DESCRIPTION OF PREFERRED EMBODIMENTS

Preferred embodiments of the present invention will be described in a more detailed manner with reference to the drawings.

Hereinafter, embodiments of a plasma display apparatus of the present invention and a driving method thereof will be described in detail with reference to the attached drawings.

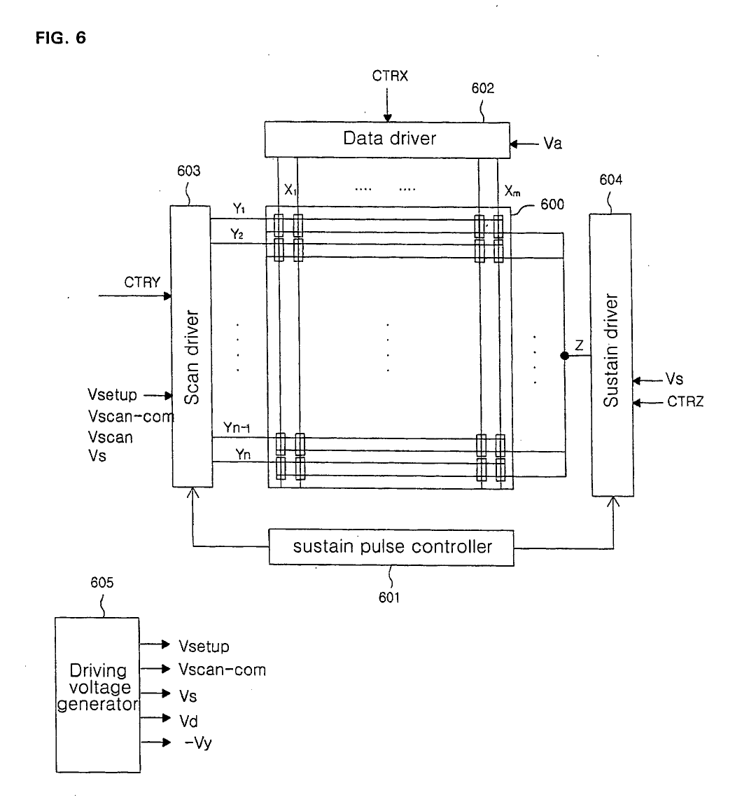

FIG. 6 is a diagram illustrating a structure of a plasma display apparatus according to an embodiment of the present invention.

As shown in FIG. 6, the plasma display apparatus according to the present invention comprises a plasma display panel 600, a sustain pulse controller 601, a data driver 602, a scan driver 603, a sustain driver 604, and a driving voltage generator 605.

The plasma display panel 600 comprises scan electrodes (Y1 to Yn), a sustain electrode (Z), and a plurality of address electrodes (X1 to Xm) intersecting the s can electrodes (Y1 to Yn) and the sustain electrode (Z), and expresses an image consisting of a frame of a combination of at least one subfield in which a driving pulse is applied to the address electrodes (X1 to Xm), the scan electrodes (Y1 to Yn), and the sustain electrode (Z) in a reset period, an address period, and a sustain period.

The data driver 602 supplies data to the address electrodes (X1 to Xm) formed in the plasma display panel 600. The scan driver 603 drives the scan electrodes (Y1 to Yn). The sustain driver 604 drives the sustain electrode (Z) that is a common electrode.

The sustain pulse controller 601 controls the scan driver 603 and the sustain driver 604 upon driving the plasma display panel 600. The driving voltage generator 605 supplies a driving voltage required for each of the drivers 602, 603, and 604.

In the plasma display panel 600, a front panel (not shown) and a rear panel (not shown) are coupled to each other at a given distance therebetween, a plurality of electrodes, for example, the scan electrodes (Y1 to Yn) and the sustain electrode (Z) are formed in pairs, and the address electrodes (X1 to Xm) are formed to intersect the scan electrodes (Y1 to Yn) and the sustain electrode (Z).

The data driver 602 receives data, which is inverse-gamma corrected and error diffused in an inverse gamma correction circuit (not shown) and an error diffusion circuit (not shown) and then mapped to each of subfields in a subfield mapping circuit. The data driver 602 supplies the data, which are sampled and latched in response to a timing control signal (CTRX) supplied from the timing controller (not shown), to the address electrodes (X1 to Xm).

The scan driver 603 supplies a ramp-up waveform and a ramp-down waveform to the scan electrodes (Y1 to Yn) during a reset period. Furthermore, the scan driver 603 sequentially supplies a scan pulse of a scan voltage (−Vy) to the scan electrodes (Y1 to Yn) during an address period and supplies a sustain pulse depending on the control of the sustain pulse controller 601 to the scan electrodes (Y1 to Yn) during a sustain period.

The sustain driver 604 supplies a bias voltage of a sustain voltage (Vs) to the sustain electrodes (Z) during a period in which a ramp-down waveform is generated and an address period and alternately operates with the scan driver 603 during a sustain period under the control of the sustain pulse controller 601 to supply the sustain pulse to the sustain electrodes (Z).

The sustain pulse controller 601 generates timing control signals (CTRY and CTRZ) for controlling an operation timing and synchronization of the scan driver 603 and the sustain driver 604, controls scan driver 603 and sustain driver 604, and supplies the timing control signal (CTRY) to the scan driver 603 and the timing control signal (CTRZ) to the sustain driver 604 in a sustain period to control the scan driver 603 and the sustain driver 604.

Specifically, the sustain pulse controller 601 adjusts at least one of an ER-Up time period and an ER-Down time period of the sustain pulse supplied to the scan electrode and the sustain electrode of the plasma display panel 600 depending on an average picture level (APL) in a sustain period.

Furthermore, the sustain pulse controller 601 can set the ER-Up time period of the sustain pulse to be shorter than the ER-Down time period. Since the discharge is performed in the ER-Up time period, it is advantageous that the ER-Up time period is shorter than the ER-Down time period.

On the other hand, the data control signal (CTRX) comprises a sampling clock for sampling data, a latch control signal, and a switch control signal for controlling on and off time of an energy recovery circuit and a driving switch element. The scan control signal (CTRY) comprises a switch control signal for controlling on and off time of the energy recovery circuit and the driving switch element within the scan driver 603. The sustain control signal (CTRZ) comprises a switch control signal for controlling on and off time of the energy recovery circuit and the driving switch element within the sustain driver 604.

The driving voltage generator 605 generates a setup voltage (Vsetup), a scan common voltage (Vscan-com), a scan voltage (−Vy), a sustain voltage (Vs), and a data voltage (Vd), etc. These driving voltages can change depending on a composition of a discharge gas or a structure of a discharge cell.

A function of the plasma display apparatus of the present invention having such a structure will be clearly apparent from descriptions of a driving method to be described later. Exemplary embodiments of a driving method to be performed by the plasma display apparatus of the present invention having such a structure will be described.

Before describing the driving method of a plasma display panel according to the present invention, the average picture level (APL) is first described in detail for a better understanding of the driving method of the plasma display panel.

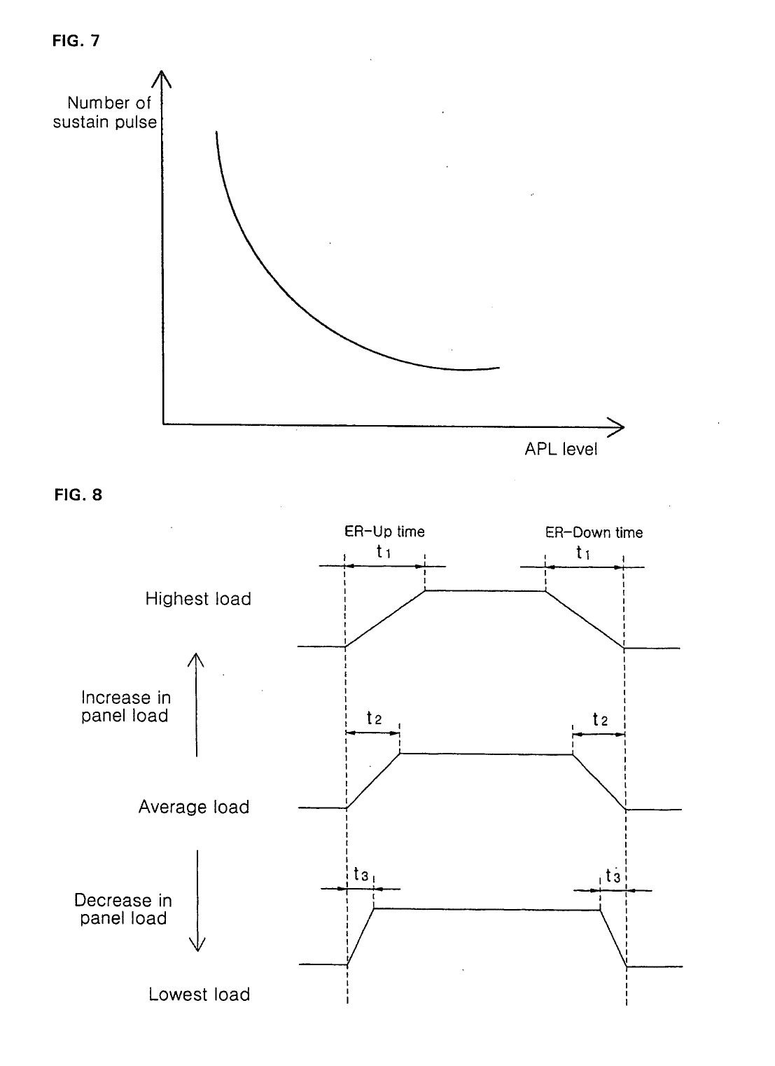

FIG. 7 is a diagram illustrating an average picture level (APL).

As shown in FIG. 7, as a value of the APL increases, the number of the sustain pulses decreases and as a value of the average picture level (APL) decreases, the number of the sustain pulses increases. The number of the sustain pulses means the number of the sustain pulses applied to a subfield or a frame.

For example, when an image is displayed only in a part of a relatively small area in a screen of the plasma display panel, i.e., when an average picture level (APL) is relatively low, the number of discharge cells to contribute to the display of an image is relatively small. Accordingly, an entire power consumption amount of the plasma display panel is reduced by supplying the relatively many number of sustain pulses to each of the discharge cells to contribute to the display of an image.

Furthermore, an entire image quality of the plasma display panel is improved by raising brightness of a part in which an image is displayed. When the average picture level (APL) is relatively low, the number of discharge cells to be turn-on is small in an entire plasma display panel and a value of a line load is relatively small.

Alternatively, when an image is displayed only in a part of a relatively large area in a screen of the plasma display panel, i.e., when an average picture level (APL) is relatively high, the number of discharge cells to contribute to the display of an image is relatively large. Accordingly, an entire power consumption amount of the plasma display panel is reduced by supplying the relatively few number of sustain pulses to each of the discharge cells to contribute to the display of an image.

When the average picture level (APL) is relatively high, the number of discharge cell to be turn-on is large in the entire plasma display panel and a value of a line load is relatively large.

In this way, when an image is displayed in a part of a relatively large area in a screen of the plasma display panel, power consumption decreases by reducing the number of the sustain pulses supplied to each of the discharge cells. In addition, when an image is displayed in a part of a relatively small area in a screen of the plasma display panel, decrease of the entire brightness is compensated by increasing the number of the sustain pulses supplied to each of the discharge cells. Accordingly, it is possible to reduce power consumption while suppressing decrease of the brightness embodied in the entire plasma display panel.

FIG. 8 is a diagram illustrating an embodiment of a driving method of the plasma display apparatus of the present invention.

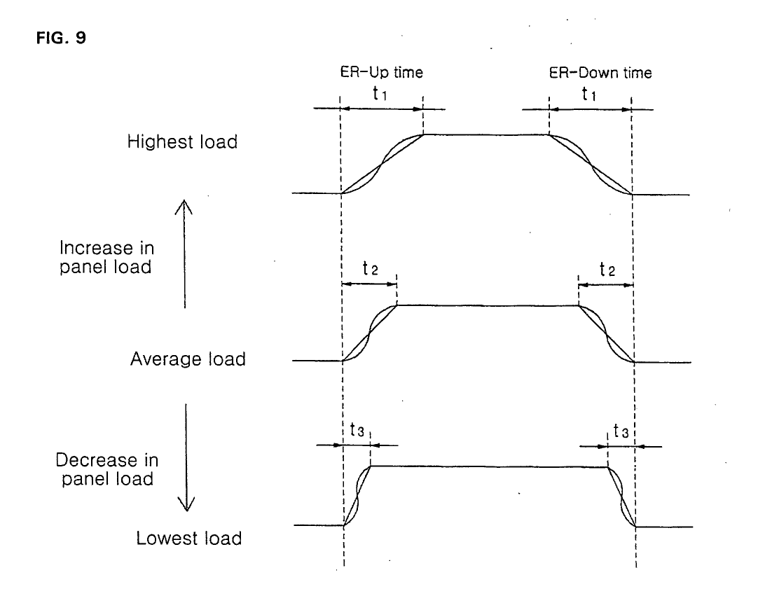

FIG. 9 is a diagram illustrating a form of a LC resonance of a sustain pulse according to an average picture level in a driving waveform of FIG. 8.

Referring to FIG. 8, at least one of the ER-Up time period and the ER-Down time period is adjusted depending on a load value of the panel having the average picture level (APL) in a driving waveform of the present invention. An ER-Up time period and an ER-Down time period, i.e., a switching time for performing ER-Up and ER-Down provided by the driving apparatus are adjusted depending on a voltage rising time period and a voltage falling time period of the sustain pulse which change depending on a value of the average picture level (APL).

For example, as in FIG. 8, in the plasma display panel, when an average image level becomes an average level by turning on of approximately a half of the discharge cells of the plasma display panel, the panel is in an average load and at this time, the sustain pulse has a form of the average load shown in FIG. 8.

In case of an average load, the ER-Up time period and the ER-Down time period are t2, respectively. In case of the average load, because the LC resonance time period agrees with the ER-Up time period or the ER-Down time period, the sustain pulse rises and falls without distortion of a waveform during the ER-Up time period and the ER-Down time period as in the average load of FIG. 9. In this case, driving efficiency of the plasma display panel is relatively high.

Furthermore, when an average image level becomes a lowest level by turning off most of discharge cells of the plasma display panel, the panel is in a lowest load and at this time, the sustain pulse has a form of the lowest load shown in FIG. 8.

In case of the lowest load, the ER-Up time period and the ER-Down time period p rovided b y the driving apparatus are t3, respectively. In case of the lowest load, because the LC resonance time period agrees with the ER-Up time period or the ER-Down time period, similarly to the average load, the sustain pulse rises and falls without distortion of a waveform during the ER-Up time period and the ER-Down time period as in the lowest load of FIG. 9. In this case, driving efficiency of the plasma display panel is relatively high.

In other words, when the average picture level (APL) is in a lowest load, the average picture level (APL) is low, i.e., a load value of the panel is relatively small. Accordingly, a voltage rising time period and a voltage falling time period of the sustain pulse calculated by Equation 1 are relatively short. Therefore, when a voltage rising time period and a voltage falling time period of the sustain pulse are short due to a low average picture level (APL), a winding of the sustain pulse is prevented by setting the ER-Up time period and the ER-Down time period to be short, so that discharge is stabilized and driving efficiency increases.

Furthermore, when an average image level becomes a highest level by turning on most of discharge cells of the plasma display panel, the panel is in a highest load and at this time, the sustain pulse has a form of the highest load shown in FIG. 8.

In case of the highest load, the ER-Up time period and the ER-Down time period provided by the driving apparatus are t1, respectively. In case of the highest load, because the LC resonance time period agrees with the ER-Up time period or the ER-Down time period, similarly to the average load, the sustain pulse rises and falls without distortion of a waveform during the ER-Up time period and the ER-Down time period as in the highest load of FIG. 9. In this case, driving efficiency of the plasma display panel is relatively high.

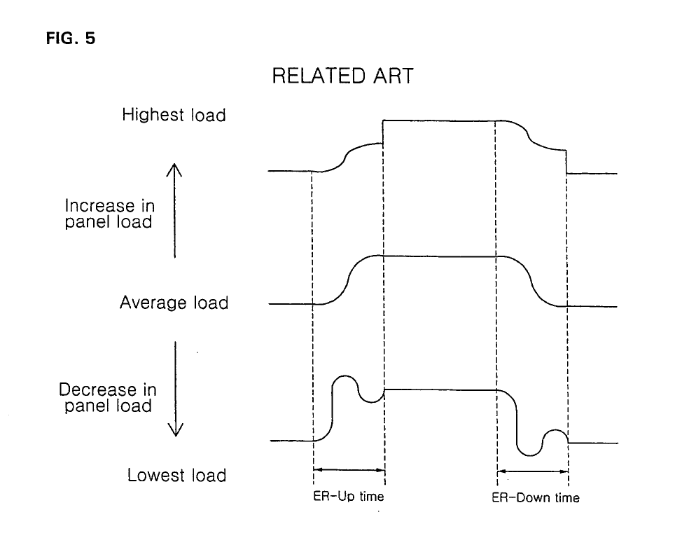

In other words, when the average picture level (APL) is in a highest load, the average picture level (APL) is high, i.e., a load value of the panel is relatively large. Accordingly, a voltage rising time period and a voltage falling time period of the sustain pulse calculated by Equation 1 are relatively long. Therefore, when a voltage rising time period and a voltage falling time period of the sustain pulse are long due to a high average picture level (APL), a phenomenon in which rising or falling of a voltage ends before the sustain pulse rises up to a highest point by LC resonance is prevented as in the highest load of FIG. 5 by setting the ER-Up time period and the ER-Down time period to be large, so that decrease in energy recovery efficiency of the driving apparatus is suppressed and driving efficiency of the plasma display panel increases.

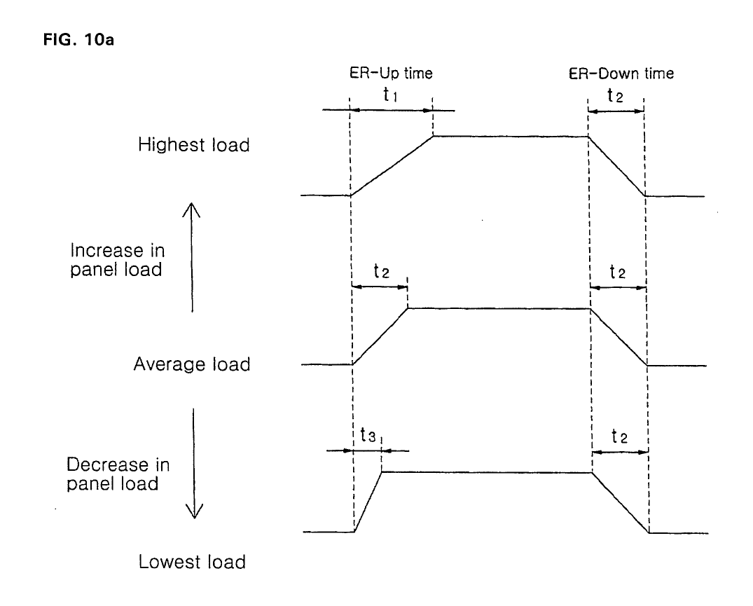

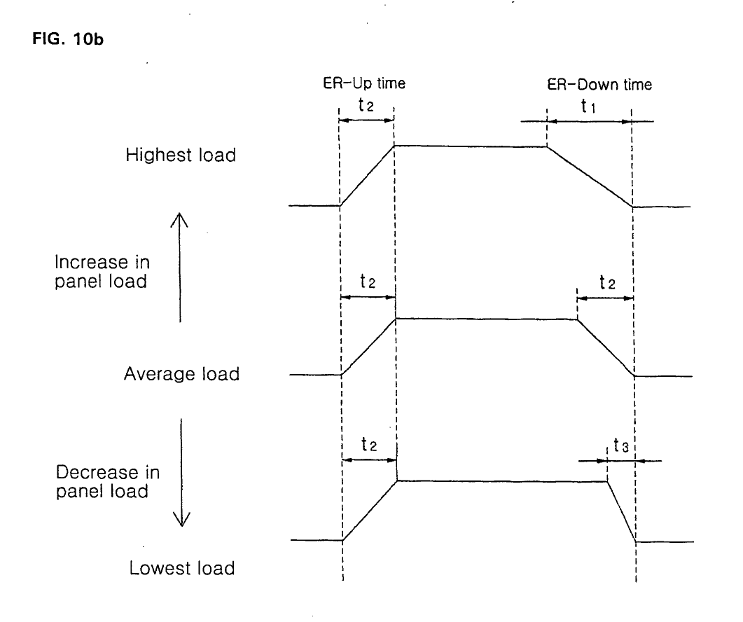

In the first embodiment of a driving method of the plasma display panel according to the present invention, both of the ER-Up time period and the ER-Down time period are adjusted depending on the average picture level (APL), but only one of the ER-Up time period and the ER-Down time period may be adjusted. This is shown in FIG. 10a or FIG. 10b.

FIG. 10a and FIG. 10b is a diagram illustrating a method of adjusting only one of an ER-Up time period and an ER-Down time period depending on an average picture level in the driving waveform of the present invention.

First, FIG. 10a shows a method of adjusting only the ER-Up time period among the ER-Up time period and the ER-Down time period. In this method, in the average picture level (APL), an ER-Up time period, i.e., a switching time for performing ER-Up provided by the driving apparatus is adjusted depending on a voltage rising time period of a sustain pulse which changes depending on a load value of the panel.

For example, as in FIG. 10a, when the plasma display panel is in an average load, the sustain pulse has a form of the average load shown in FIG. 8. In case of the average load, the ER-Up time period and the ER-Down time period are t2, respectively.

Furthermore, when the plasma display panel is in a lowest load, the sustain pulse has a form of the lowest load shown in FIG. 10a. In case of the lowest load, the ER-Up time period provided by the driving apparatus is t3 and is shorter than that of the average load, and the ER-Down time period is t2, which is equal to that of the average load.

Furthermore, when the plasma display panel is in a highest load, the sustain pulse has a form of the highest load shown in FIG. 10a. In case of the highest load, the ER-Up time period provided by the driving apparatus is t` and increases than that of the average load and the ER-Down time period is t2, which is equal to that of the average load.

In this way, by adjusting only one of the ER-Up time period and the ER-Down time period depending on the average picture level (APL), driving efficiency thereof increases and the control thereof is easier than that in FIG. 8 upon driving the plasma display panel.

FIG. 10b shows a method of adjusting only the ER-Down time period among the ER-Up time period and the ER-Down time period. That is, the ER-Down time period, i.e., a switching time for performing ER-Down provided by the driving apparatus is adjusted depending on a voltage falling time period of the sustain pulse which changes depending on the average picture level (APL), i.e., a load value of the panel.

A driving waveform of FIG. 10b is substantially equal to that of FIG. 10a and thus descriptions thereof will be omitted.

In the above description, by adjusting at least one of the ER-Up time period and the E R-Down time period depending on the average picture level (APL), only a case where a width of the sustain pulse, i.e., a length of the duration of the sustain voltage (Vs) changes is described.

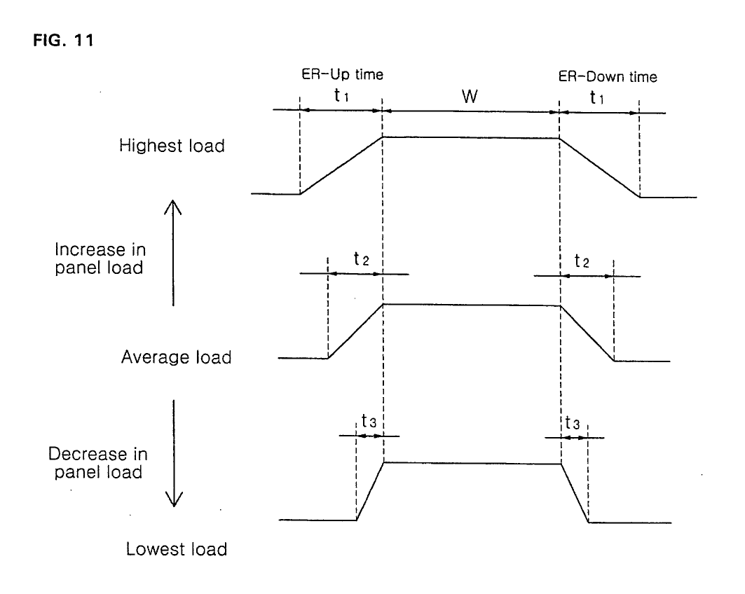

FIG. 11 shows a method of uniformly maintaining a length of the duration of a sustain voltage of the sustain pulse while adjusting the ER-Up time period and the ER-Down time period depending on an average picture level in a driving waveform of the present invention.

As shown in FIG. 11, when the plasma display panel is in an average load, a highest load, and a lowest load, the ER-Up time period and the ER-Down time period are different in each case, but a length of the duration of the sustain voltage (Vs) is fixed at a value of W.

By uniformly maintaining a length of the duration of the sustain voltage (Vs) of the sustain pulse regardless of the change in the average picture level (APL), an amount of light generated by one sustain pulse can be uniformly maintained in each case. Finally, the control of discharge becomes easier.

Although FIG. 11 shows a case where the ER-Up time period and the ER-Down time period are adjusted depending on the average picture level (APL), but it is possible to uniformly maintain a length of the duration of a sustain voltage of the sustain pulse while adjusting at least one of the ER-Up time period and the ER-Down time period depending on the average picture level (APL).

Furthermore, the ER-Up time period of the sustain pulse may set to be shorter than the ER-Down time period thereof. Because discharge is generated in the ER-Up time period, it is advantageous that the ER-Up time period is shorter than the ER-Down time period.

As described in detail above, according to the present invention, by adjusting at least one of the ER-Up time period and the ER-Down time period depending on the average picture level (APL), driving efficiency of the plasma display panel is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a plurality of electrodes;
a driver for driving the plurality of electrodes; and
a sustain pulse controller for controlling the driver and for adjusting at least one of an ER (energy recovery)-Up time period and an ER (energy recovery)-Down time period of a sustain pulse supplied to the plurality of electrodes depending on an average picture level (APL) in a sustain period.

2. The plasma display apparatus of claim 1, wherein the sustain pulse controller increases at least one of the ER-Up time period and the ER-Down time period of the sustain pulse as the average picture level (APL) increases.

3. The plasma display apparatus of claim 1, wherein the sustain pulse controller decreases at least one of the ER-Up time period and the ER-Down time period of the sustain pulse as the average picture level (APL) decreases.

4. The plasma display apparatus of claim 1, wherein the driver comprises a scan driver and a sustain driver.

5. The plasma display apparatus of claim 1, wherein the sustain pulse controller uniformly maintains the duration of a sustain voltage of the sustain pulse.

6. The plasma display apparatus of claim 1, wherein the sustain pulse controller sets the ER-Up time period to be shorter than the ER-Down time period.

7. A method of driving a plasma display apparatus comprising:
adjusting at least one of an ER-Up time period and an ER-Down time period of a sustain pulse supplied to a plurality of electrodes depending on an average picture level (APL) in a sustain period of a plasma display panel.

8. The method of claim 7, wherein the adjusting is to increase at least one of the ER-Up time period and an ER-Down time period of the sustain pulse as the average picture level (APL) increases.

9. The method of claim 7, wherein the adjusting is to decrease at least one of the ER-Up time period and the ER-Down time period of the sustain pulse as the average picture level (APL) decreases.

10. The method of claim 7, wherein the adjusting is to control a scan driver and a sustain driver.

11. The method of claim 7, wherein the adjusting is to uniformly maintain the duration of a sustain voltage of the sustain pulse.

12. The method of claim 7, wherein the adjusting is to set the ER-Up time period to be shorter than the ER-Down time period.

13. A method of driving a plasma display apparatus comprising:
driving a plurality of electrodes of a plasma display panel in a reset period and an address period; and
adjusting at least one of an ER-Up time period and an ER-Down time period of a sustain pulse supplied to the plurality of electrodes depending on the number of sustain pulses in a sustain period.

14. The method of claim 13, wherein the adjusting is to increase at least one of the ER-Up time period and the ER-Down time period of the sustain pulse as the number of sustain pulses decreases.

15. The method of claim 13, wherein the adjusting is to decrease at least one of the ER-Up time period and the ER-Down time period of the sustain pulse as the number of sustain pulses increases.

16. The method of claim 13, wherein the number of sustain pulses is equal to the number of sustain pulses supplied to a subfield or a frame.

17. A plasma display apparatus comprising:
a plasma display panel comprising a plurality of electrodes;
a driver for driving the plurality of electrodes; and
a sustain pulse controller for controlling the driver, for adjusting at least one of an ER-Up time period and an ER-Down time period of a sustain pulse supplied to the plurality of electrodes depending on an average picture level (APL) in a sustain period, and for setting the ER-Up time period to be shorter than the ER-Down time period.

18. The plasma display apparatus of claim 17, wherein the sustain pulse controller increases at least one of the ER-Up time period or the ER-Down time period of the sustain pulse as the average picture level (APL) increases.

19. The plasma display apparatus of claim 17, wherein the sustain pulse controller decreases at least one of the ER-Up time period and the ER-Down time period of the sustain pulse as the average picture level (APL) decreases.

20. The plasma display apparatus of claim 17, wherein the sustain pulse controller uniformly maintains a sustain period of a sustain voltage of the sustain pulse.
